(19) United States
(12) Patent Application Publication
(10) Pub. No.: US 2007/0116462 A1
(43) Pub. Date: May 24, 2007

(54) DEVICE FOR OPTICALLY SWITCHING BETWEEN UPSTREAM AND DOWNSTREAM OPTICAL LINES, WITH NODE SIGNATURE ADDITION FOR TRACKING OPTICAL CONNECTION PATHS

(75) Inventors: Pierre Peloso, Morconrris (FR); Thierry Zami, Massy (FR); Bruno Lavigne, Antony (FR); Dominique Chiaroni, Antony (FR); Ludovic Noirie, Nozay (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/561,402

(22) Filed: Nov. 19, 2006

(30) Foreign Application Priority Data
Nov. 24, 2005 (FR) 0553589

(51) Int. Cl. H04J 14/00

(52) U.S. Cl. 398/45

(57) ABSTRACT

A device (D) is dedicated to optical switching in a switching node (NC) of a transparent optical network. This device (D) comprises i) at least one input port adapted to be coupled to an upstream optical line (FE1-FE4) dedicated to the transport of multiplexed channels, ii) at least one exit point, iii) switching means (MC) coupling each input port at least to each exit point, and iv) processing means (MT1-MT4) adapted to add to the channels that reach each input port a signature including first information representative of that switching node (NC), and where applicable the input port that received them.

The invention concerns transparent optical networks, and more precisely tracking optical connection paths set up within such networks, via their switching nodes.

Here “optical connection path” means a physical path within a transparent optical network that is taken by optical signals emitted at a given wavelength. Such physical paths are defined by portions of optical lines generally consisting of optical fibers and connecting pairs of transparent switching nodes.

The signals are transported in channels (logical pipes) each associated with an optical connection path.

Moreover, “transparent optical network” here means a network in which the channels remain at all times in the optical domain.

Furthermore, “transparent switching node” here means a network equipment including at least one optical switching device, of transparent type, adapted to switch channels at wavelengths that have been multiplexed or are to be multiplexed coming from upstream optical lines and to be sent to downstream optical lines.

Additionally, “multiplex” here means a set of channels with different wavelengths conjointly utilizing the same medium.

As the person skilled in the art knows, it is particularly important for operators to know if the optical connection paths that are set up between the switching nodes of their transparent optical networks are adequate for the respective programming states of the optical switching devices of those switching nodes. Any inadequacy results from a problem of programming, of operation of a switching node or in an optical line portion, which problem must be solved.

In order to verify the adequacy cited above, methods called “tracking and verification of optical connection paths” are used in the networks. This verification thus verifies the connectivity of an optical connection path, i.e. if the channel connects the right source to the right destination. In a non-transparent optical network, this is relatively easy because there are effected in the switching nodes signal conversions of optical/electrical/optical type that, by the addition of control traffic, verify that each receiver is indeed connected to the corresponding source at the level of each link.

This is not the case in a transparent optical network because of the absence of signal conversion of optical/electrical/optical type (the optical switching devices in fact operate at the level of the physical layer, and more precisely on the wavelengths of the channels).

Several solutions to this problem have been proposed.

A first solution, which is the extrapolation of what happens in a non-transparent network, consists in injecting control traffic into the optical lines in order to test the match between the source and the destination of the different optical connection paths. This solution has the major drawback of consuming bandwidth as well as that of delivering no information on the location of a possible error, which makes repair more difficult.

A second solution consists in associating with each signal source (and thus with each signal) used in the network at least one frequency that is applied to the channel by overmodulation. By analyzing a wavelength at a selected place in the network the overmodulation frequency or frequencies applied can be determined and thus the channel that is present can be determined using information supplied by the manager of the network. That information is at least the correspondence between the overmodulation frequencies and the channels, which determines the path taken by this channel. This solution is proposed by the company Tropics under the trade name “Wavelength Tracker®“.

This second solution necessitates the use of a number of processing modules, for example of the variable optical attenuator (VOA) type, equal to the number of channels used in the network. The variable optical attenuators are placed upstream of each add port of an optical switching device to overmodulate the channels to be added to the traffic. This causes high costs and gives rise to problems if it is wished to transform a network of a certain size into a network of greater size (i.e. scalability problems), because of the new overmodulation frequencies that must be applied to the new channel.

A third solution consists in adding locally to each channel that has reached one of the input ports of a switching node an overmodulation the frequency whereof is dedicated to said receiver input port. The number of overmodulation frequencies used locally in each switching node is therefore equal to the number of input ports. Each overmodulated channel is analyzed upstream (or downstream) of the exit points (output ports and/or drop ports) of the switching node in which it was subjected to said overmodulation in order to determine the switching path that it has followed within that switching node, after which this overmodulation is eliminated from the analyzed channel in order for it to continue to follow its route within the network. This third solution is described in U.S. Pat. No. 6,559,984.

The drawback of this third solution is that it provides only for local analyses (i.e. analyses within each node) and not for end-to-end tracking of optical connection paths, by analyzing the channels only at the level of the switching node in which they are used. Moreover the number of VOAs necessary for deleting channels generates prohibitive costs.

An object of the invention is therefore to remedy at least some of the drawbacks of the known solutions.

To this end it proposes an optical switching device for a switching node of a transparent optical network, comprising, firstly, at least one input port adapted to be coupled to an upstream optical line dedicated to the transport of multiplexed channels, secondly, at least one exit point (output port intended to be coupled to a downstream optical line dedicated to the transport of multiplexed channels, or drop port), and, thirdly, switching means coupling each input port to each exit point.

The optical switching device is characterized in that it further comprises processing means disposed at the level of said at least one input port to add to the channels that reach each input port of said switching device a signature including first information representative at least of that switching node.

Here “signature” means any modification applied to a channel or multiplex to mark the passage at a given point of this channel or of the channels constituting this multiplex.

The device of the invention may have other features that may be applied separately or in combination, and among others:
its processing means may be adapted to add to each channel (or each channel of each multiplex) a signature including first information representative of their own switching node and second information representative of the input port that received this channel;
its processing means may be adapted to apply the same amplitude overmodulation at a selected frequency (constituting first information) representative of the switching node to each channel (or each channel of each multiplex) received via each input port;
its processing means may for example be adapted to apply to the first information (where applicable to the overmodulations) applied to the channels received via different input (and add) ports amplitude overmodulations at different frequencies or different phase shifts (forming second information) respectively representative of the input (or add) ports;
its processing means may include processing modules the number of which is at least equal to the number of input ports and each of which is adapted to add the signature to the channels received via the corresponding input port;
its processing means may include at least one additional processing module adapted to add the signature to the channels introduced via an add port coupled to an add module;
its processing means may include additional processing modules the number of which is equal to the number of add ports and each of which is adapted to add the signature to the channels introduced via the corresponding add port;
each processing module may for example take the form of an electrically controlled variable optical attenuator;
it may further comprise analysis means adapted to analyze the channels that are delivered via at least some of the exit points, to determine at least the signature that has been added to them by the processing means of the switching node;
these analysis means may be adapted to determine a physical state of the switching device from the determination of the channels delivered by an or each exit point and the signature that has been added to each of the channels by the processing means of the switching device, to verify that there is a correspondence between the physical state of the switching device and a programming state defining the channels that must be delivered at said or each exit point and the input ports on which the channels must reach the switching device, and to generate an alarm message if there is no correspondence;
these analysis means may be adapted to analyze the channels delivered via exit points to determine each signature that has been added to them by the processing means of each switching node through which they have passed in transit, including their own;
these analysis means may be adapted to analyze each second information item added to each first information item of each channel by the processing means of each switching node through which it has passed in transit, including their own;
these analysis means may for example include a number of analysis modules equal to the number of exit points to be analyzed and each adapted to analyze the channels received by the corresponding exit point;
alternatively, there may be provided a switch comprising inputs respectively coupled to the exit points to be analyzed and to at least one output, and analysis means including a mutualized analysis module comprising an input coupled to the output of the switch and adapted to analyze the channels received by one of the exit points to be analyzed, selected by the switch;
each analysis module may for example comprise an optical filtering sub-module adapted to separate the channels delivered by the corresponding exit point, as well as at least one optical/electrical conversion sub-module adapted to convert each channel into an electrical signal, and an electrical analysis sub-module adapted to identify each signature added to each separate channel;
its processing means may be adapted to apply a signature to all the channels of a multiplex simultaneously;
its switching means may comprise, firstly, a first stage including N broadcasting modules each having a first input, coupled to one of the input ports, and M first outputs, each adapted to deliver at least one of the multiplexed channels received by the first input, secondly, a second stage including M merging modules each having N second inputs, each adapted to receive at least one channel at one wavelength, and a second output coupled to an output port constituting one of the exit points and adapted to deliver at least one channel received on one of the second inputs, and, thirdly, a third stage including at least N×M optical links coupling at least the first outputs to the second inputs so that each of the N broadcasting modules is coupled to each of the M merging modules;
these broadcasting modules may for example be chosen from optical couplers with one input and M outputs and wavelength selection modules, for example of the WSS type;
these merging modules may for example be chosen from optical couplers with N inputs and one output and wavelength selection modules, for example of the WSS type. It will be noted that either the merging modules are of non-selective type and the broadcasting modules of selective type or the merging modules are of selective type and the broadcasting modules of non-selective or selective type.

The invention also proposes a switching node, for a (D)WDM network, equipped with at least one optical switching device of the type described hereinabove. Such switching nodes may for example take the form of a transparent optical cross-connect.

Other features and advantages of the invention will become apparent on examining the following detailed description and the appended drawings, in which:

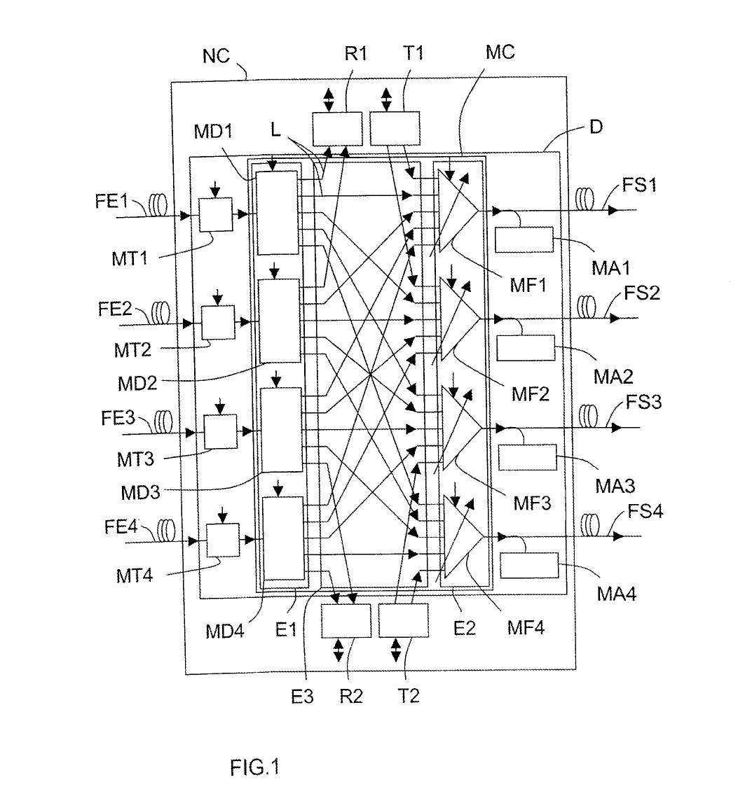

FIG. 1 is a functional block schematic of a first embodiment of an optical switching device according to the invention, and

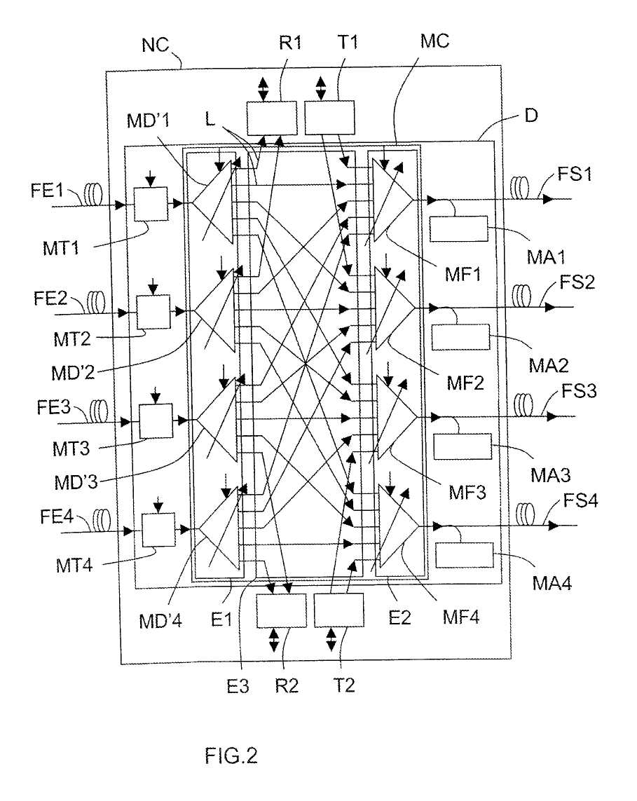

FIG. 2 is a functional block schematic of a second embodiment of an optical switching device according to the invention.

The appended drawings constitute part of the description of the invention as well as contributing to the definition of the invention, if necessary.

An object of the invention is to track optical connection paths set up in a transparent optical network, either in a local analysis mode (i.e. using analyses effected in each switching node of the network) or in an end-to-end analysis mode (i.e. using analyses effected in each (“last”) switching node that is at the end of an optical connection path).

Hereinafter, it is considered by way of nonlimiting example that the switching nodes are transparent optical cross-connects (OXC), where applicable with an add and/or drop function, of a Wavelength Division Multiplexing (or (Dense) Wavelength Division Multiplexing (D)WDM) network.

However, they could equally be optical add/drop multiplexers (OADM).

Firstly, it is pointed out that that an optical connection path is a physical route within a transparent optical network taken by optical signals emitted at a given wavelength and that the signals are transported in channels (logical pipes) each associated with an optical connection path. Such physical routes (or paths) are defined by portions of optical lines generally consisting of optical fibers and connecting pairs of transparent switching nodes.

Moreover, channels associated with different wavelengths and together using the same medium may be multiplexed in order to constitute a multiplex.

As is shown in FIGS. 1 and 2, a (switching) node NC comprises at least one optical switching device D according to the invention.

The device D firstly has N input ports respectively coupled to optical input lines FEi (i=1 to N), for example optical fibers, in which multiplexed channels, also called optical signal spectral multiplexes, “circulate”. In the examples shown in FIGS. 1 and 2, the index i takes values from 1 to 4, because N is equal to 4 (for illustrative purposes). However, this index i is not limited to these values, which are fixed by the number N of input ports of the device D. It may in fact take any value from 1 to N, with N greater than or equal to one (N≧1).

For example each input optical fiber FEi can transport R optical channels (R>0).

The device D also has M output ports respectively coupled to optical output lines FSj (j−1 to M), for example optical fibers, in which multiplexed channels, also called optical signal spectral multiplexes, “circulate”. In the examples shown in FIGS. 1 and 2, the index j takes values from 1 to 4, because M is equal to 4 (for illustrative purposes). However, this index j is not limited to these values, which are fixed by the number M of output ports of the device D. It may in fact take any value from 1 to M, with M greater than or equal to one (M≧1).

It is important to note that the M output ports constitute M exit points. However, as will become clear hereinafter the device may have one or more other exit points each defining a drop port. Consequently, here exit point means either an output port coupled to an output optical line FSj or a drop port.

The device D also includes a switching module MC that may be functionally divided into a first stage E1, a second stage E2 and a third stage E3. Any type of switching module MC may be envisaged, not only that described hereinafter with reference to FIGS. 1 and 2.

The first stage E1 (shown in FIGS. 1 and 2) includes N broadcasting modules MDi (i=1 to N) each having at least one first input and M first outputs. As indicated hereinabove, in the example shown in FIGS. 1 and 2, N and M are equal to four (N=4, M=4), but N like M may take any value greater than or equal to one (N≧1, M≧1).

Each first input is intended to be coupled to an input port of the device D and therefore to an input optical line FEi.

Each broadcasting module MDi is adapted to switch multiplexed optical channels that it receives at its input (coupled to an input optical line FEi) as a function of their respective wavelengths to one or more of its M first outputs. In other words, a broadcasting module MDi provides an “internal routing” function that delivers to each of its M first outputs one or more (or even all) optical channels of a multiplex that it has received at its single input.

In the embodiments shown in FIGS. 1 and 2, each broadcasting module MDi has a first drop output that is coupled to a drop port (or exit point) of a drop module of one or more channels R1 or R2 of the node NC. In a variant, the drop modules R1 and R2 could be part of the device D. Moreover, in FIGS. 1 and 2 there are represented two separate drop modules, but they could be combined into a single module. This first drop output recovers at the level of the node NC the signals that are contained in one or more channels transported by any of the input lines FEi, with a view to local processing and/or transmission to at least one terminal connected to the node NC.

In the first embodiment, shown in FIG. 1, the broadcasting modules MDi are of nonselective type. They are for example optical splitters adapted to deliver at each first output all optical channels received at their first input.

In a variant, the broadcasting modules could be of selective type. This is the case in the second embodiment shown in FIG. 2 in particular. In this case, they constitute for example wavelength selection modules (MD'i) of WSS type, such as those described in the introduction. These wavelength selection modules MD'i are adjustable as a function of a control signal and can deliver at each of their M first outputs, as a function of a specific control signal, either an optical channel selected from the optical channels received at their first input or a multiplex consisting of a set of optical channels selected from the optical channels of the multiplex received at their first input. It is important to note that each channel received at the first input can be distributed only to one first output. The selection of the channels is effected internally by means of integrated filters.

The WSS modules are described for instance in “The MWS 1×4: A High Performance Wavelength Switching Building Block”, T. Ducellier et al., ECOC'2002 conference, Copenhagen, 9 Sep. 2002, 2.3.1.

The wavelength selection modules of type WSS are advantageous because, among other things, they induce low insertion losses compared to those induced by simple couplers, when their number of outputs (M) is greater than 4.

The second stage E2 (shown in FIGS. 1 and 2) includes M merging modules MFj each having N second inputs and at least one second output that is coupled to one of the M output ports of the device D, and therefore to one of the M optical output lines FSj.

Each merging module MFj provides an (where applicable programmable) internal switching function supplying at one or more second outputs either an optical channel selected from the optical channels received at its N second inputs or a multiplex consisting of a set of optical channels selected from the optical channels received at its N second inputs.

In the embodiments shown in FIGS. 1 and 2, each merging module MFj comprises a second add window that is coupled to an add module of one or more channels T1 or T2 of the node NC. In a variant, the add modules T1 and T2 could be part of the device D. Moreover, in FIGS. 1 and 2 there are represented two separate add modules, but they could be grouped into a single module. This second add input feeds the merging module MFj concerned with one or more channels in order, where applicable, to multiplex it or them with other channels received via at least one of its other second inputs.

In the embodiments shown in FIGS. 1 and 2, the merging modules MFj are of selective type. They are for example wavelength selection modules of WSS type, such as those described hereinabove and in the introduction. In this case, they are adjustable as a function of a control signal and can deliver at their single second output, as a function of a specific control signal, either an optical channel selected from the optical channels received at their N second inputs or a multiplex consisting of a set of optical channels selected from the optical channels received on their N second inputs.

However, in a variant, they could be of non-selective type. In this case, they constitute for example optical couplers adapted to deliver at one or more second outputs a multiplex consisting of all the optical channels received at their N second inputs.

Generally speaking, the invention applies to all implementations in which either the merging modules are of non-selective type and the broadcasting modules of selective type or the merging modules are of selective type and the broadcasting modules of non-selective or selective type.

The third stage E3 (shown in FIGS. 1 and 2) includes at least N×M optical links L each coupling one of the M first outputs of one of the N broadcasting modules MDi (or MD'i) to one of the N second inputs of one of the M merging modules MFj. As is shown in FIGS. 1 and 2, the third stage E3 may also include optical links L coupling either one of the first outputs of one of the N broadcasting modules MDi (or MD'i) to a drop port (or exit point) of one of he drop modules T1, T2 or one of the add modules R1, R2 to the second (add) input of at least one of the M merging modules MFj.

It is important to note that a broadcasting module MDi (or MD'i) may where applicable have a plurality of first drop outputs, just as a merging module MFj may where applicable have a plurality of second add inputs.

There has been described hereinabove (with reference to FIG. 1) a first or communication module MC embodiment in which the broadcasting modules MDi are all optical splitters and the merging modules MFj are all wavelength selection modules (for example of WSS type) and (with reference to FIG. 2) a second or switching module MC embodiment in which the broadcasting modules MD'i and the merging modules MFj are all wavelength selection modules (for example of WSS type). However, there may equally be envisaged at least a third embodiment in which the broadcasting modules are all wavelength selection modules (for example of WSS type) and the merging modules are all optical couplers.

The invention is not limited to the switching module MC embodiments described hereinabove, especially with reference to FIGS. 1 and 2. A device D according to the invention may in fact include any type of switching module MC. Accordingly, its switching module MC may comprise a first stage E1 taking the form of one or more demultiplexer(s) (where applicable adapted to drop channels), a second stage E2 taking the form of one or more multiplexer(s) (where applicable adapted to add channels), and a third stage E3 taking the form of a switching matrix connecting the first outputs of the demultiplexer(s) to the second inputs of the multiplexer(s).

According to the invention, a device D also comprises processing means MTi installed at the level of each of the input ports of its switching node NC and adapted to add to each channel (or to each of the channels of a multiplex) arriving at each input (and/or add) port a signal representative at least of the switching node NC in which they are installed.

Accordingly, each channel that takes an optical connection path has added to it in each node NC that it “crosses” (or which inserts it into the traffic) a signature including a first information item representative of this node NC. In other words, each channel carries the trace of its passage through each node of an optical connection path that it takes. It is then possible, as will emerge hereinafter, either to determine in each node each signature added to each channel, in order to reconstitute the path that it has taken (local analysis mode), or to determine at the level of the “last” node of an optical connection path taken by a channel each signature that has been added to it by each node of that optical connection path.

Any type of signature able to represent a node NC may be added to a channel by the processing means MTi of that node NC, provided that it does not involve an optical/electrical/optical conversion.

Remember that here “signature” means any modification applied to a channel or to a multiplex to mark that channel or the channels that compose that multiplex passing a given point.

The processing modules MTi are preferably adapted to apply a signature to all the channels of a multiplex simultaneously.

For example, the processing means MTi of a node NC may apply to each channel received via each input port the same overmodulation at frequency f_{NC} representative of their node NC and forming a first information item. In this case, each node of the network must have its own overmodulation frequency (also called the “pilot tone”).

It is preferable for each overmodulation frequency to satisfy at least two rules.

Firstly each overmodulation frequency must be sufficiently high to be transparent to the amplifiers installed on the optical lines FEi and FSj of the network, especially if the amplifiers are of EDFA (Erbium Doped Fiber Amplifier) type. In fact, this type of amplifier smoothes the signal that it amplifies if the modulations have a frequency below a first threshold. Consequently, if it is wished to retain an overmodulation on passing through an EDFA its overmodulation frequency must be above the first threshold. Typically, it is preferable for each overmodulation frequency to be higher than approximately 10 kHz.

It is then necessary for each overmodulation frequency to be sufficiently low to be outside the spectral range of the data represented by the channel signals. In fact, if an overmodulation frequency exceeds a second threshold, this may interfere with the signal because this may correspond to frequencies representative of a series of a large number of identical (0 or 1) bits. Consequently, if it is wished not to interfere with a signal it is necessary for the overmodulation frequency to be below the second threshold. Typically, it is preferable for each overmodulation frequency to be less than approximately 1 MHz.

It is important to note that the signature that is added to each channel, by the processing means MTi of a node NC, may be representative not only of that node NC, but also of the input port that received the channel. Any type of second information liable to represent an input port of a node NC (and to distinguish it from the other ports of that node NC) may be added to a channel, in addition to the first information, by the processing means MTi of that node NC, provided that it does not involve optical/electrical/optical conversion.

For example, the processing means MTi of a node NC may apply to each first information item added to each channel received via an input port a second information item representative of that input port.

In other words, each incoming wavelength channel is marked, upstream of the switching matrix, with an information item identifying the corresponding input port. Accordingly, by detecting this information at the level of an output, downstream of the switching matrix, it is possible to reconstitute the path taken by each channel inside the switching matrix (local analysis mode), and therefore to determine a physical switching state of the switching matrix. That switching state may then be compared to a programming state, resulting for example from instructions issued by a centralized management device of the network, in order to detect a malfunction of the hardware if there is no match.

For example, this second information item might take the form of a phase shift in the overmodulation applied as the first information item. In this case, the phases of the first information items, added to the channels received at different input ports, differ from each other. In the embodiments shown in FIGS. 1 and 2, the processing means MTi may for example apply a zero phase shift at the first input port coupled at the first input fiber FE1, a phase shift of π at the second input port coupled to the second input fiber FE2, a phase shift of −π/2 at the third input port coupled to the third input fiber FE3, and a phase shift of +π/2 at the fourth input port coupled to the fourth input fiber FE4.

The combination of an overmodulation at a frequency f_{NC} (representative of a given node NC) and, for example, a phase shift (representative of one of the N input ports of a node NC) forms a signature that indicates unambiguously via which input port of a node a channel has passed in transit. Because of this combination, it is not necessary to provide second information items (for example different phase shifts) for input ports of different nodes. The same multiplet of N different second information items (for example N phase shifts) may therefore be used in each node (provided that those nodes all include the same number of input ports, of course).

This embodiment may necessitate the definition within the network of references of local portions of signatures useful for determining the input port at the level of a given node NC.

Instead of applying to the channels that reach a given input port a second information item in the form of a selected phase shift applied to the first information items, there may for example by applied to them a second information item in the form of an overmodulation of the first information item according to a frequency or a combination of bits specific to that input port. In other words, according to a first variant, a node NC is allocated a batch of overmodulation frequencies identifying this node uniquely, a respective frequency from the batch being allocated to each input port of the node. According to a second variant, the overmodulation applied at the level of the input ports of a node has a particular frequency allocated to that node and additionally carries a respective binary code for distinguishing the input ports. This code may be applied in FSK (Frequency Shift Keying) modulation i.e. by modulating the frequency of the overmodulation about the value allocated to the node.

In order to add each signature at the level of each input port, the processing means MTi may be of modular form, for example, as shown in FIGS. 1 and 2. In this case, each input port has a processing module MTi adapted to add to the channels that it receives a signature representative of the node NC that it equips.

For example, each processing module MTi may be an electrically controlled variable optical attenuator (VOA). In this case, the application to a channel of a first information item (for example an overmodulation) is effected by attenuation of its power according to the frequency associated with the node NC comprising the input port that received it. This kind of processing module (VOA) MTi can also apply to each first information item a second information item, for example in the form of a selected phase shift, intended to distinguish that input port from the other input ports of the same node NC.

Types of processing module MTi other than VOA may be used to add a signature to the channels. Thus acousto-optical modules or modulators may be used, for example.

As is shown in FIGS. 1 and 2, and as mentioned hereinabove, a node NC, according to the invention, may equally include analysis means MAi coupled to at least some of the exit points of its switching device D, in order to determine, at least, the signature that has been added to each channel received by the processing means MTi installed at the input ports of the same switching device D.

Preferably, and as shown, each output port is the subject of an analysis by the analysis means. However, it may equally be envisaged that the drop ports are the subject of an analysis by the analysis means. Among other things this provides an end-to-end analysis in the final node of a network. It may equally be envisaged that only the drop ports are the subject of an analysis by the analysis means.

The analysis means MAi are preferably able to determine each signature that has been added to each channel by the processing means MTi of each switching node through which that channel has passed in transit, including their own. This is necessary especially if only the drop ports of a device D are the subject of an analysis by the analysis means MAi, which is the case in a ring network, for example.

The analysis means may be either of modular type or of mutualized type.

In the mutualized case, a single analysis module serves to analyze the signatures added to the channels delivered by a plurality of exit points (output ports and/or drop ports). In this case, each output port to be analyzed is provided with an optical Y splitter coupled, on the one hand, to the corresponding output fiber FSj and, on the other hand, to one of the inputs of a switch adapted to select one of the output ports to be analyzed and to deliver at an output the channels received by that output port to be analyzed to feed the input of the mutualized analysis module.

In the modular case, each exit point that must be the subject of an analysis has its own analysis module. This is especially the case of the output ports in the embodiment shown in FIGS. 1 and 2. More precisely, in order to determine at the level of an exit point each signature added to each channel, said exit point is provided with an optical Y splitter coupled, on the one hand, to the corresponding output fiber FSj and, on the other hand, to the corresponding analysis module MAi, and adapted to sample a small portion of the power of the channels delivered by that output port to feed that analysis module MAi. The optical Y splitter is of 95%/5% type, for example.

The method of determining a signal added to a channel depends on the type or types of techniques used to generate and add that signature. Whatever method is used, the analysis module MAi must first spectrally separate (or filter) by means of an optical filtering sub-module the channels to be analyzed, which are delivered in the form of a multiplex via an exit point (here an output port). Then, this analysis module MAi must convert the channel into an electrical signal by means of an optical/electrical conversion sub-module. The bandwidth of this sub-module is preferably appropriate to the frequencies contained in the signatures. This analysis module MAi must then analyze this electrical signal, by means of an electrical analysis sub-module, in order to identify the signatures, i.e. firstly and where applicable the frequency or frequencies of the overmodulations constituting the first information items, and secondly the phase (or the overmodulations) constituting the second information item specific to the node (or the second information items of the preceding nodes).

The optical filtering sub-module may take the form of a tunable filter, for example.

The optical/electrical conversion sub-module may take the form of a photodiode, for example, placed at the output of the optical filtering sub-module and adapted to transform the optical channels into electrical signals.

The optical filtering and optical/electrical conversion sub-modules may where applicable be assembled into a single OCM (Optical Channel Monitor) module that may be produced either by cascading a tunable filter and a photodiode or in the form of a diffraction grating splitting the wavelengths towards a strip of photodiodes.

The electrical analysis sub-module may take the form of a synchronous detection (“lock-in detection”) sub-module, for example, adapted to determine the overmodulation frequency of the electrical signals and where applicable the phase shift of this overmodulation.

Of course, the implementation of the electrical analysis sub-module varies as a function of the nature of the first and second information items.

Thanks to this type of analysis of the channels, it is possible to determine in a node NC each signature added to each channel, and therefore (if the overmodulation frequency associated with each node is known) to determine at least each node through which it has passed in transit, as well as each input port used in each transit node, where applicable. Knowing the input ports that receive the channels, there may be deduced therefrom the output ports of the nodes which they have passed through in transit and that are coupled to these input nodes. It is therefore possible to reconstitute the path taken previously by each channel at each analysis point.

It will be noted that at least some of the channel add ports (outputs of the add modules T1 and T2) may have an (additional) processing module MTi of the same type as those described hereinabove. If they do not have processing modules MTi, the channels that are added in a given node do not include a signature when they reach the level of an output port of that node. Despite this, the absence of a signature on a channel constitutes a signature that is valid locally because it indicates that the channel was added in the current node.

Moreover, if the management plan informs the nodes of the channels that must reach each of their input ports and the channels that must be delivered at each of their output ports, the analysis means MAi may verify if the physical state of their switching device D actually corresponds to its logical state. If these states do not correspond (or match), the analysis means MAi deduce from this that there is a problem, and may generate an alarm message, for example, in order to have implemented a protection mechanism intended to remedy the problem detected.

The invention is not limited to the optical switching device and communication node embodiments described hereinabove by way of example only, but encompasses all variants that the person skilled in the art might envisage within the scope of the following claims.

1. Optical switching device (D) for a switching node (NC) of a transparent optical network, comprising i) at least one input port adapted to be coupled to an upstream optical line (FEi) dedicated to the transport of multiplexed channels, ii) at least one exit point, and iii) switching means (MC) coupling each input port to each exit point, characterized in that it further comprises processing means (MTi) disposed at the level of said at least one input port to add to the channels that reach each input port of said switching device (D) a signature including first information representative at least of that switching node (NC).

2. Device according to claim 1, characterized in that said processing means (MTi) are adapted to add to each channel a signature including first information representative of their own switching node (NC) and second information representative of the input port that received this channel.

3. Device according to either claim 1, characterized in that said processing means (MTi) are adapted to apply the same amplitude overmodulation at a selected frequency constituting first information and representative of said switching node (NC) to each channel received via each input port.

4. Device according to claim 2, characterized in that said processing means (MTi) are adapted to apply to the first information applied to the channels received via different input ports second information in the form of different phase shifts respectively representative of said input ports.

5. Device according to claim 2, characterized in that said processing means (MTi) are adapted to apply to the first information applied to the channels received via different input ports second information in the form of amplitude overmodulations at different frequencies respectively representative of said input ports.

6. Device according to claim 1, characterized in that said processing means include processing modules (MTi) the number of which is at least equal to the number of said input ports and each of which is adapted to add said signature to the channels received via the corresponding input port.

7. Device according to claim 1, characterized in that said processing means (MTi) include at least one additional processing module adapted to add said signature to the channels introduced via an add port coupled to an add module (T1, T2).

8. Device according to claim 7, characterized in that said processing means (MTi) include additional processing modules the number of which is equal to the number of add ports and each of which is adapted to add said signature to the channels introduced via the corresponding add port.

9. Device according to claim 6, characterized in that each processing module (MTi) is adapted to add selected second information to the first information.

10. Device according to claim 6, characterized in that each processing module (MTi) takes the form of an electrically controlled variable optical attenuator.

11. Device according to claim 2, characterized in that it further comprises analysis means (MAi) adapted to analyze the channels that are delivered via at least some of the exit points, to determine at least the signature that has been added to them by said processing means (MTi) of said switching node (NC).

12. Device according to claim 11, characterized in that said analysis means (MAi) are adapted to analyze the channels delivered via exit points to determine each signature that has been added to them by the processing means (MTi) of each switching node (NC) through which they have passed in transit.

13. Device according to claim 11, characterized in that said analysis means include analysis modules (MAi) the number of which is equal to the number of exit points to be analyzed and each of which is adapted to analyze the channels received via the corresponding exit point.

14. Device according to claim 11, characterized in that it comprises a switch comprising inputs respectively coupled to the exit points to be analyzed and to at least one output and said analysis means include a mutualized analysis module comprising an input coupled to the output of said switch and adapted to analyze the channels received via one of said exit points to be analyzed, selected by said switch.

15. Device according to claim 11, characterized in that said analysis means include at least one analysis module (MAi), which comprises an optical filter sub-module for separating the channels delivered via the corresponding exit point, at least one optical/electrical conversion sub-module for converting each channel into an electrical signal, and an electrical analysis sub-module for identifying each signature added to each separate channel.

16. Device according to claim 11, characterized in that said analysis means (MA) are adapted to determine a physical state of the switching device (D) from the determination of the channels delivered via an exit point and the signature that has been added to each of said channels by said processing means (MT) of the switching device, to verify that there is a correspondence between said physical state of the switching device and a programming state defining the channels that must be delivered at said exit point and the input ports on which said channels must reach said switching device, and to generate an alarm message if there is no correspondence.

17. Device according to claim 1, characterized in that said switching means (MC) comprise i) a first stage (E1) including N broadcasting modules (MDi; MD'i) each having a first input, coupled to one of said input ports, and M first outputs, each adapted to deliver at least one of the multiplexed channels received via said first input, ii) a second stage (E2) including M merging modules (MFj) each having N second inputs, each adapted to receive at least one channel at a wavelength, and a second output coupled to an output port constituting one of said exit points and adapted to deliver at least one channel received on one of said second inputs, and iii) a third stage (E3) including at least N×M optical links (L) coupling at least said first outputs to said second inputs so that each of the N broadcasting modules (MDi; MD'i) is coupled to each of the M merging modules (MFj).

18. Device according to claim 17, characterized in that said broadcasting modules (MDi; MD'i) are selected from a group comprising optical couplers with one input and M outputs and wavelength selection modules.

19. Device according to either claim 17, characterized in that said merging modules (MFj) are selected from a group comprising optical couplers with N inputs and one output and wavelength selection modules.

20. Device according to claim 19, characterized in that said wavelength selection modules (MDi; MD'i, MFj) are of the type known as “WSS”.
